(19) United States
(12) Patent Application Publication
(10) Pub. No.: US 2010/0145925 A1
(43) Pub. Date: Jun. 10, 2010

(54) METHOD AND ARRANGEMENT FOR ENABLING COMMUNICATION WITH A CLIENT DEVICE

(76) Inventors: Christofer Flinta, Stockholm (SE); Jan-Erik Mangs, Solna (SE); Anders E. Eriksson, Kista (SE)

Correspondence Address: ERICSSON INC., 6300 LEGACY DRIVE, M/S EVR 1-C-11, PLANO, TX, 75024, US

(21) Appl. No.: 12/442,897

(22) PCT Filed: Sep. 15, 2006
(86) PCT No.: PCT/SE2006/001053

§ 371 Date: Feb. 23, 2010

(51) Int. Cl. G06F 17/30

(52) U.S. Cl. 707/709; 707/E17.108

(57) ABSTRACT

A method and arrangement for enabling communication with a client device by making a currently valid communication address of the device publicly available. The client device sends a freely composed connectivity key to a publicly available connectivity server, the connectivity key being searchable by means of web searching using a search engine. The client device also sends connectivity parameters to the connectivity server including at least the communication address, which then becomes publicly available in the connectivity server by web searching of the associated connectivity key. If a new currently valid communication address is obtained for the client device, the connectivity parameters can be updated by sending the new communication address to the connectivity server.

### TECHNICAL FIELD

The present invention relates generally to a method and arrangement for making a communication address, e.g. the IP (Internet Protocol) address, currently used by a client device easily available to any other person, device or application in order to enable communication.

### BACKGROUND

The advent of Internet has created a vast industry for making all kinds of information and data available from servers to any user operating a communication terminal equipped with a web browser. A server offering information over the Internet can be accessed from any such client device by entering a domain name in the web browser, which has been registered for that server. The domain name is then translated into a corresponding IP address serving as the network address of the server to which messages and requests can be routed, as the domain name itself cannot be used for routing. IP addressing is the generally used standard for communication over the Internet.

Most likely, the Internet and the IP addressing will also be used to a great extent in the future for packet-based communication between various client devices, sometimes referred to as “Peer-to-Peer” communication. A mechanism is then needed for making the currently used IP address (or other applicable network address) of a client device easily available to any person, device or application that might want to communicate with that particular client device over the Internet.

As indicated above, all client devices and servers must typically have a routable IP address in order to be capable of communication with others over the Internet. IP addresses are typically composed of numbers separated by dots, e.g. 192.78.32.1, according to well-known structures and rules which are not necessary to describe here in any detail to understand the present invention. IP addresses that are globally unique can be allocated to servers and different access networks all over the world by a central administrator. Each access network operator can then assign IP addresses to individual subscribers and client devices in the network according to local rules and schemes.

With the emergence of 3G mobile telephony, new packet-based communication technologies have been developed using IP addressing for mobile terminals, including GPRS (General Packet Radio Service) and WCDMA (Wideband Code Division Multiple Access). When a mobile terminal connects to such a packet-based mobile access network, a PDP (Packet Data Protocol) context including certain communication parameters is established for the terminal so as to prepare for any upcoming session, which is a normal procedure in any packet-based mobile networks. The PDP context is always created by the home network of the mobile terminal, even if it is currently visiting another network.

Establishing a PDP context includes assigning a temporary IP address to the mobile terminal which is stored together with a subscriber identity, e.g. MSISDN (Mobile Subscriber ISDN Number), in a session database. Typically, at least in WCDMA networks and GPRS networks, the GGSN (Gateway GPRS Support Node) creates the PDP context by fetching a temporary IP address from a DHCP (Dynamic Host Configuration Protocol) server assigning idle temporary IP addresses to active mobile terminals. The procedure of establishing a PDP context for a mobile terminal is well-known and is not necessary to describe here further.

The terminal can then use its assigned temporary IP address for packet-switched communication throughout its active period in the access network, until it is disconnected. When the terminal is connected once again, a new PDP context is established typically rendering a new temporary IP address other than the previous one, and so forth. The temporary IP address may also be changed whenever the terminal moves from one mobile access network to another, or moves between different regions within the same network using different sets of IP addresses, etc.

Other types of access networks use fixed access points to which any subscriber can connect his/her client device, either wirelessly or using a wire jack plug. In this case, the network operator may assign an IP address more or less permanently to such an access point, which is then used for any client device that connects to that access point. In this type of networks, subscribers can typically move their client devices freely between different access points.

Hence, it can be readily understood from the above that the IP address for a particular client device may be frequently changed, and it is therefore not feasible for a user to retain a contact list of IP addresses for client devices as it becomes outdated in due course. A mechanism is therefore needed for keeping the currently used IP address up to date and available for anyone (a person, device or application) wanting to reach the client device. Therefore, a domain name is commonly used as an alias for whatever IP address is currently used for communication over the Internet. As mentioned above, the use of domain names has been widely practiced for servers having permanent IP addresses, but it can also be used for client devices. The conventional use of domain names in this context will be briefly outlined below.

A domain name can thus be registered with a domain name registration authority for a particular communication node (e.g. a host server or client device), according to conventional procedures, as being associated with the IP address valid for that node. A domain name basically comprises words or codes separated by dots, and may be included in a URL (Unified Resource Locator). An exemplary server domain name is www.ericsson.com. More personal domain names can also be registered for client devices, e.g. based on a personal name such as www.christoferflinta.se, or a telephone number such as www.070123456.se, etc.

The domain name can be entered in a web browser and is then translated into a corresponding IP address, in order to access the node using that IP address and domain name combination. Each domain name is thus associated with an IP address that has been assigned to the corresponding node, as the domain name itself cannot be used directly as a network address but must be translated into one for routing.

Registrations of domain names are made in specific domain name servers that are organized in a so-called “DNS (Domain Name Service) tree” structure, as is well-known in the art. Typically, a fixed host server or the like has a permanent IP address and will therefore not require any updating, but also end-users can register domain names for their PC stations or other devices, e.g. using temporary IP addresses. In that case, the association of a domain name with an IP address must be updated with the registration authority each time the IP address is changed.

FIG. 1 illustrates schematically how a DNS tree 100 is built logically, comprising a plurality of servers of which just a few are shown here. In effect, the DNS servers make up a distributed hierarchically structured database containing registered domain names and their associated IP addresses, where each level in the tree corresponds to a word position in a domain name, as separated by the dots therein.

The top level 102 of the tree 100 has a singular root server, and the next level 104 contains a number of servers representing a word after the last dot in a domain name, e.g. “.com” and “.se” as illustrated, which may be a generic code or a country code. The next level 106 contains a number of so-called “top level domain” servers representing the next word in a domain name, e.g. “x.se”, “y.se”, “z.se” as illustrated, and so forth. In this example, the server representing the domain name “z.se” covers a set 108 of complete domain names and their corresponding IP addresses, although in reality, the DNS tree includes many more possible levels.

Briefly described, a “requester” 110 (in the figure representing, e.g., a PC or a mobile telephone equipped with a web browser) intends to send a message directed to a specific domain name that a user has entered in the web browser, without initially knowing which IP address it is associated with. In order to send the message, the associated IP address must be found if unknown. To obtain the IP address, the domain name is first transferred to a “resolver” entity 112, in a first step 1:1. The resolver 112 is adapted to access the DNS tree at different levels to retrieve the IP address, basically as follows. In practice, a resolver may logically reside in the operative system running in the requester equipment, or in a specific node in the access network.

In operation, the resolver 112 may cache IP address information on earlier accessed domain names, but if the resolver does not recognise the domain name at all, it will query the DNS tree at successive levels, one at a time. Thus, in a step 1:2, the resolver 112 may initially query the root server at the first level 102 regarding the last field in the domain name, e.g. “.se ?”, if not known already. The root server then responds by pointing to the corresponding server in the next level 104. When querying the “.se” server at level 104 in a following step 1:3 regarding the next field in the domain name, e.g. “z.se?”, it will respond by pointing to the corresponding server in the next level 106 which is then accessed in step 1:4, and so forth. When the last server is reached finally providing the IP address associated with the complete domain name, the resolver delivers the IP address back to the requester 110, in a last shown step 1:5.

FIG. 2 illustrates a conventional procedure for registering a domain name for a mobile terminal A currently in connection with a mobile access network 200. When terminal A connects to the access network, the network establishes a PDP context as described above and stores it together with a subscriber identity in a session database SDB 202. Terminal A receives the assigned temporary IP address from network 200 in a first step 2:1, to be used for packet communication throughout its active period until the mobile terminal is disconnected.

A specific software in the mobile terminal for registering a domain name issues a registration request to a domain name registration authority 204, in a step 2:2, including the desired domain name together with the temporary IP address received in step 2:1. The domain name is then registered with the IP address in the DNS tree 206 in a step 2:3. Any other user 208, mobile or fixed, can then retrieve the current IP address of terminal A, as shown by a final step 2:4, e.g. by means of a resolver (not shown) as described above.

However, there are some problems associated with the current technique for providing IP addresses of client devices. In particular, the current concept of domain name registration in DNS servers has some serious drawbacks. The registration procedure and selection of domain names must follow certain strict rules and schemes, seriously limiting options for users. Some amount of security is also required involving authentication routines, etc. There are also some other proprietary solutions for address handling, e.g. Skype and Outlook, but these are not always compatible with other applications.

In order to keep IP addresses available by means of domain names, considerable efforts and costs must be spent on maintaining the DNS tree and its servers organized and up to date, to make the above-described resolver process work smoothly. The update rates for individual client devices may also be relatively slow, resulting in out-of-date information in the DNS servers for mobile users frequently changing their IP addresses. Further, the above-mentioned DNS and proprietary solutions do not allow for storing additional information that may be useful to share with others.

Further issues to deal with are that a user, or even a particular service, may change between different client devices, and a client device may furthermore have several IP addresses. It is not evident for another user which device and/or address to use for contacting that user or service.

Generally speaking, there is no solution today for making a currently valid communication address (typically the IP address) of a client device easily available to any person, device or application that might need it for communication with the client device or any other purpose. A solution is therefore desirable that can avoid or at least reduce the problems and drawbacks associated with the conventional technique described above.

In this context, a “communication address” could be any network address that can be used directly to communicate with the client device, i.e. a network address such as an IP address, an MAC (Medium Access Control) address or an SIP (Session Initiation Protocol) address. IP networks may also use a DNS name to identify a network address.

### SUMMARY

It is an object of the present invention to generally address the problems outlined above and to provide a flexible and simple way of making a currently valid communication address (typically the IP address) of a client device easily available, e.g., to other client devices. These objects and others can be obtained by a method and apparatus according to the attached independent claims.

In some aspects of the present invention, a method and an arrangement are provided that can be implemented in a client device for making its currently valid communication address publicly available. The client device sends a freely composed connectivity key to a publicly available connectivity server, wherein the connectivity key is searchable by means of web searching using a search engine. The client device also sends connectivity parameters associated with the connectivity key to the connectivity server. The connectivity parameters includes at least the communication address of the client device, which then becomes publicly available in the connectivity server by web searching of the associated connectivity key. The client device comprises means for executing the above actions.

The communication address can be a network address including any of: an IP address, an MAC address, an SIP address and a DNS name. The connectivity parameters is updated in the connectivity server, whenever a new currently valid communication address different from the previous one is obtained for the client device, by sending the new communication address to the connectivity server.

The client device may have received the connectivity key as input from a user. Alternatively, the key may have been automatically selected by default. The connectivity key may contain user and/or device identification data that may include a user name and/or a telephone number. The connectivity key may further contain descriptive information the user has selected for characterization.

The connectivity parameters may further include capabilities of the client device and/or application specific data. Encryption may be used when sending the connectivity key and/or associated connectivity parameters to the connectivity server. If the connectivity server is divided into a main server and a distributed separate client database to which the connectivity parameters are sent, an alias for the client device can be sent to the main server that other client devices can use for accessing the client database and the connectivity parameters stored therein.

In other aspects of the present invention, a method and an arrangement are provided that can be implemented in a publicly available connectivity server for making a currently valid communication address of a client device publicly available, which can be used for communication with the client device. In the connectivity server, a freely composed connectivity key is received which is searchable by means of web searching using a search engine. Connectivity parameters associated with the connectivity key are also received, including at least the communication address of the client device. The connectivity server then stores a connectivity record for the client device including the received connectivity key and associated connectivity parameters, thereby making the connectivity parameters publicly available by web searching of the associated connectivity key. The connectivity server comprises means for executing the above actions.

The received communication address can be a network address including any of: an IP address, an MAC address, an SIP address and a DNS name. The connectivity parameters can be updated in the connectivity record, if a new currently valid communication address obtained for the client device and different from the first one, is received.

The connectivity server may be implemented in a web hotel or other large web site run by a known operator. The received connectivity parameters may further include capabilities of the client device and/or application specific data. Encryption can be used when receiving the connectivity key and/or the associated connectivity parameters.

The connectivity key and connectivity parameters may be received from the client device, although at least the communication address can be received instead from a communication network responsible for assigning a network address to the client device.

The connectivity server may comprise a main server and a distributed separate client database in which the connectivity parameters are received. An alias for the client device can then be received in the main server that other client devices can use for accessing the client database and the connectivity parameters stored therein.

Access to all or some of the connectivity parameters in the connectivity record may be restricted to specific users or groups of users by means of encryption or login requirements.

Further features and benefits of the present invention will become apparent from the detailed description below.

### BRIEF DESCRIPTION OF THE DRAWINGS

The present invention will now be described in more detail by means of preferred embodiments and with reference to the accompanying drawings, in which:

FIG. 1 is a schematic block diagram illustrating a conventional signalling procedure for obtaining an IP address from a DNS tree based on a given domain name, according to the prior art.

FIG. 2 is a schematic block diagram illustrating a procedure for registering a domain name, according to the prior art.

FIG. 3 is a flow chart illustrating a basic procedure for making a communication address of a client device publicly available, in accordance with the present invention.

FIG. 3a is a schematic block diagram illustrating a signalling procedure when the network address of a client device B is provided to another client device A, in accordance with one embodiment.

FIG. 4 is a flow chart illustrating a procedure in a client device for making its network address publicly available and updated, in accordance with another embodiment.

FIG. 5 is a flow chart illustrating a procedure in a connectivity server for making the network address of a client device publicly available and updated, in accordance with yet another embodiment.

FIG. 6 is a schematic block diagram illustrating a client device and a connectivity server in which the network address of the client device is made publicly available, in accordance with yet another embodiment.

FIG. 7 is a schematic block diagram illustrating a signalling procedure when the network address of a client device B is provided to another client device A, in accordance with yet another embodiment.

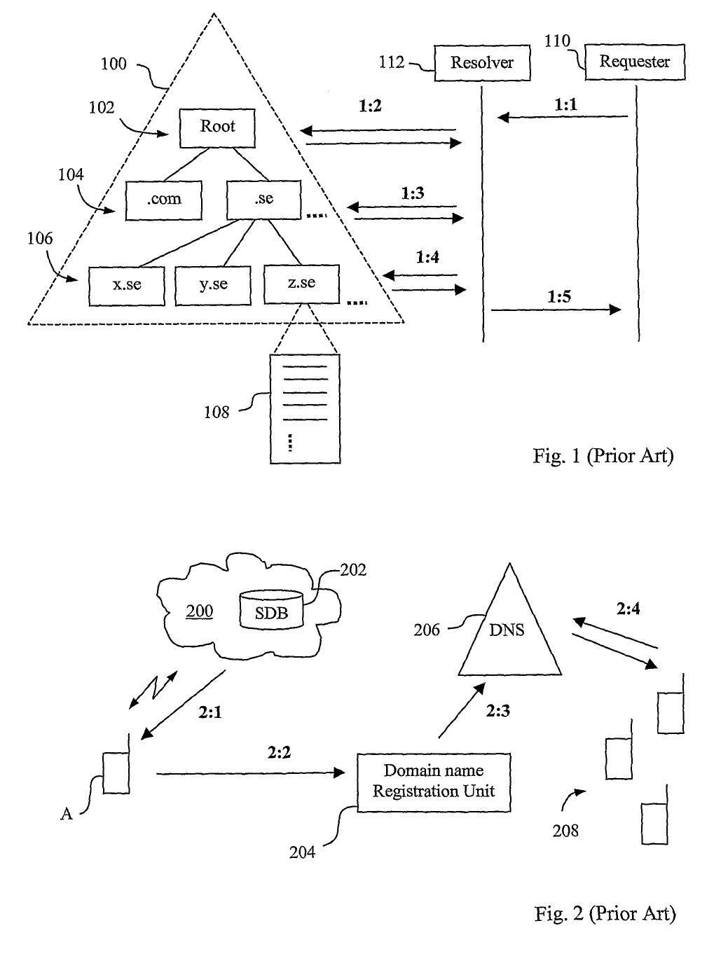

### DETAILED DESCRIPTION

Briefly described, the present solution utilises a generally available and generic web site, in this description referred to as a “connectivity server” which may be a single server entity or a distributed system of plural servers. The currently valid communication address (i.e. a network address, typically an IP address) of any client device can be stored as a “connectivity parameter” in the connectivity server together with a searchable freely composed text string and/or other information element valid for that client device, in this description referred to as a “connectivity key”. One or more connectivity parameters including at least the communication address are also stored associated with the connectivity key in the connectivity server.

In the present solution, the connectivity key is searchable by means of conventional web searching using a search engine, thereby making the associated communication address easily available to any person, device or application that might need it for communication or any other purpose. The communication address and its associated connectivity key are preferably registered as a record for the client device in the connectivity server and can be updated anytime, particularly when the IP address or other communication address is changed for the client device, or when its user wants to change or modify the connectivity key.

The connectivity key may be composed of any text string of optional length and content, and a user controlling or administrating the client device is free to select any piece of description or name or other information to make up the connectivity key. Thus, it is not necessary to comply with any rules or schemes when composing the connectivity key, in contrast to the above-described strict domain name registration in a DNS server. In fact, the present invention allows for enclosing any information in the connectivity key that might be useful, e.g. for any layer in the protocol stack used.

The stored communication address and its associated searchable connectivity key should be globally available from the connectivity server in a web page or the like. It is then possible for any person, device or application to retrieve the communication address of the client device by making a conventional web search for terms or word combinations that might occur in the connectivity key, e.g. by means of any existing public search engine such as Google or Yahoo, or a proprietary search engine.

If successful, the search result can be obtained from the search engine preferably as a URL of the connectivity server, specifically pointing to the web page containing the complete connectivity key and associated communication address of the searched client device. This is possible since, according to conventional procedures, the used search engine is able to find a match between the entered search profile for the searched client device and the connectivity key stored for that client device in the connectivity server.

Alternatively, an alias or the like may be stored for the client device along with the connectivity key in the connectivity server, whereas the communication address as well as any further connectivity parameters are stored in a separate client database. The alias can then be used by other client devices for obtaining the communication address from the client database. The alias may then be a reference code or the like such as a unique private name, and could also include a URL or other reference pointing to the corresponding communication address in the client database.

Using the present invention, a multitude of connectivity servers and client databases accommodating communication addresses and associated connectivity keys of various client devices may be scattered around the world. It is not at all required that the connectivity servers are organized or mutually related in any way, in great contrast to the centrally organized tree structure of DNS servers. Further aspects and features of the present solution will be discussed in the following examples.

In the examples below, the term “IP address” is used throughout as it is generally implemented today as a communication address in packet-switched networks. However, it should be understood that any valid network address serving as communication address can substitute the IP address when applicable, e.g. an MAC address, an SIP address or a DNS name.

The term “client device” will also be used throughout this description to represent any type of communication terminals used by persons to execute voice calls and/or multimedia sessions over the Internet, including any fixed and wireless telephones and computers or the like capable of packet-switched Internet communication. The concept of “client” and “server” is well-known, and the present invention may generally be useful to both client-server oriented communication and symmetric client-client (i.e. Peer-to-Peer) communication.

As mentioned above, the term “connectivity server” in this context is not limited to implementation in a single server entity, but may also represent a logic entity that can be implemented as a distributed system of plural servers and databases.

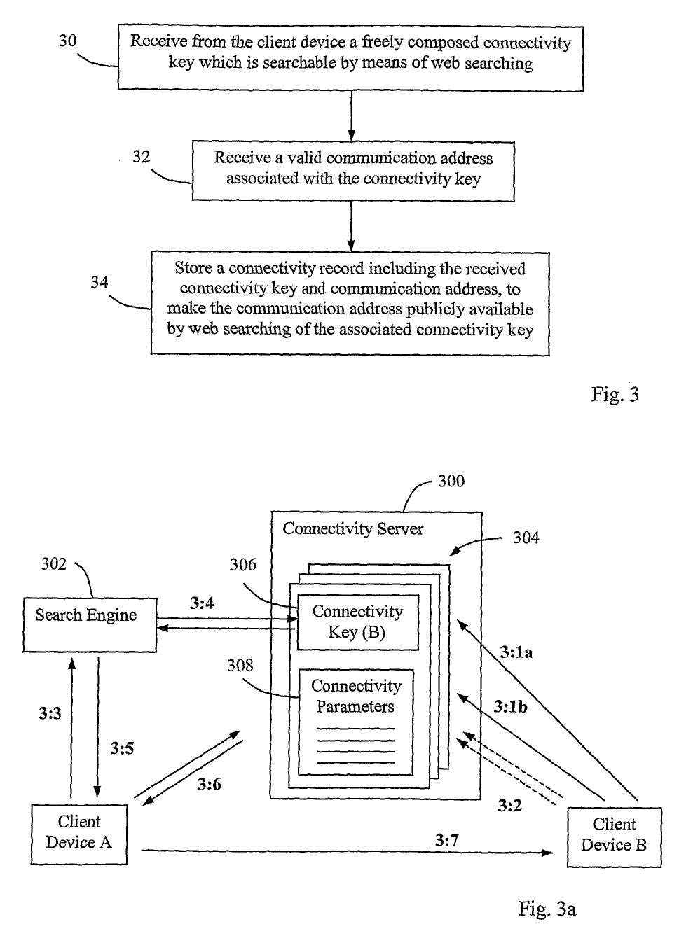

FIG. 3 is a flow chart illustrating steps in a connectivity server for making the communication address of a client terminal available, in accordance with the present solution. In a first step 30, a freely composed connectivity key is received from a client device which is searchable by means of web searching using a search engine, e.g. according to conventional web searching procedures such as Google or Yahoo, or a proprietary search engine.

In a next step 32, a communication address currently valid for the client device is received from the client device. Thereby, the communication address is associated with the connectivity key. Finally, a connectivity record is stored in the connectivity server in a step 34, including the received connectivity key and associated communication address, to make the communication address publicly available by web searching of the associated connectivity key. The connectivity record contains connectivity parameters including at least the communication address.

An embodiment for making an IP address of a client device B available to another client device A will now be described with reference to FIG. 3a. In this case, the IP address is used as an example of a communication address. Client device A is thus used for contacting client device B, the latter being registered in a connectivity server 300 basically as described above. It is assumed that client device B has obtained an IP address for communication, e.g. by means of a PDP context or by connecting to a fixed access point as described above. It is further assumed that the current IP address used by client device B is unknown to client device A and its user, and must be retrieved in order to contact client device B. The user of device A can then use a suitable search engine 302 to retrieve the current IP address of client device B according to the following.

The client device B initially executes a registration procedure for storing a record 304 in the connectivity server 300, containing a freely composed connectivity key 306 and associated connectivity parameters 308 including at least the currently used IP address. This initial registration can be divided into in a first substep 3:1a of uploading the connectivity key 306 to the connectivity server 300, and a second substep 3:1b of uploading associated connectivity parameters 308. Steps 3:1a and 3:1b can be executed basically independent of each other.

Client device B may be specifically adapted to communicate suitable messages with the connectivity server 300 during the registration procedure to create the connectivity record. As indicated in the figure, the connectivity server 300 may accommodate a plurality of such connectivity records 304 for various other client devices as well, although this is not actually necessary.

In addition to the IP address, the connectivity parameters 308 may optionally include further information that could be helpful for the communication, such as various capabilities of client device B and application specific data, e.g. available codecs, link bandwidth and port number. This information may also facilitate the mobility of the device, user and/or ongoing session. Further, the connectivity parameters 308 and/or key 306 may be encrypted to control access thereto for security.

The connectivity key 306 can be defined in any manner, without limitation as to length and content. For example, it may contain the user's name, telephone number, as well as other user and/or device identification data. It may also contain any other descriptive information the user has selected, e.g., for characterization such as occupations, titles, memberships, interests, hobbies, etc. In fact, the selection of suitable contents in the connectivity key may be used to control to which extent it can be found by other users by means of search engines. Also, different information in the connectivity key 306 may be inserted to address different users, e.g. by means of public keys.

The first substep 3:1a of uploading the connectivity key 306 effectively creates a database entry, i.e. the record 304, for client device B in connectivity server 300. Any subsequent uploading of associated connectivity parameters 308 or modification of the connectivity key 306 may refer to this entry or record 304 of client device B by means of a reference code such as a user name or the like, generally serving as a register index.

Thus, after initial registration of the connectivity record 304, client device B may update any parts thereof whenever needed or desired, as schematically illustrated by an optional step 3:2. In particular, the IP address of device B should be updated if changed for whatever reason, e.g. as exemplified in the background section. Further connectivity parameters 308 may also be changed and updated accordingly. The user or administrator of client device B may also optionally change or modify the connectivity key 306, if desired.

Any existing protocol can be used by client device B for uploading updated information in the connectivity record 304, such as the well-known File Transfer Protocol FTP. Security may also be obtained by requiring a user identity/password combination for uploading and updating the connectivity parameters and/or connectivity key. Encryption may also be used in the communication during the registration and updating procedures to further enhance security.

In this example, client device A now generally intends to contact client device B for communication, e.g. a voice call or multimedia session, which may basically be initiated by a user or an application in the device A. However, the IP address of device B is unknown at device A, as mentioned above. Therefore, client device A sends a search query in a next step 3:3 to the search engine 302, using a selected search profile as input to a web search. For example, the name, telephone number and/or other identification data may constitute a search profile in the query, optionally combined with any other terms or phrases that might match the correct connectivity key.

Using conventional technique not necessary to describe here, search engine 302 then performs a search and finds a match, in a step 3:4, between the input search profile and the connectivity key 306 of device B stored in connectivity server 300. The present solution does not exclude that search engine 302 also finds other matches (not shown) between the search profile and information on different web sites, just like any conventional web search over the Internet might do. In other words, the search result does not need to be unique as the receiving user or device may be capable of identifying the correct one, either manually or by means of a suitable application in the device. However, this functionality lies outside the scope of the present invention.

In response to the search query of step 3:3, search engine 302 delivers the search result to client device A in a next step 3:5, preferably including a URL of the connectivity server 300 (as well as further search hits, if any). The obtained URL also points specifically to the web page therein containing the record 304 with the matching connectivity key of the searched client device B and its associated IP address.

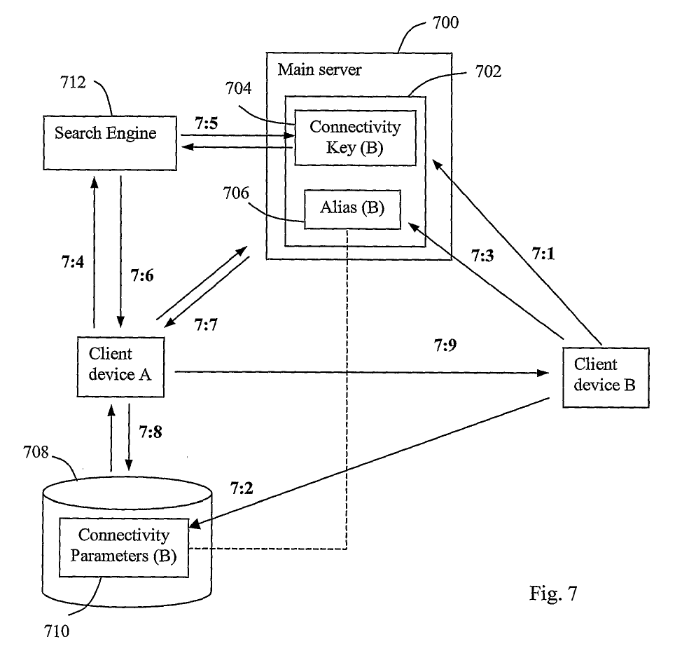

In an alternative embodiment, to be described in more detail later below with reference to FIG. 7, the IP address and other connectivity parameters may be stored in a database separate from the connectivity server 300, where the database may actually be seen as a distributed part of the described connectivity server function. An alias or the like for client device B may then be stored together with the connectivity key 306 in the connectivity server 300. In that case, the search result (i.e. the record 304) would contain the connectivity key of the searched client device B and its alias, which the client device A can use for accessing that database and the connectivity parameters (including at least the IP address) stored therein.

In a following step 3:6, client device A uses the received URL in a conventional manner to access connectivity server 300 and to retrieve the complete connectivity record 304 of client device B, where the necessary IP address is found, according to the present embodiment. If further URL's are received from search engine 302 in step 3:5 as a result of plural hits by means of the given search profile, it should be possible for the user and/or client device A to identify the correct one, e.g., by checking the contents of the connectivity key 306.

After extracting the received IP address, client device A can contact client device B by means of a suitable session initiating message using that IP address as the destination, in a final step 3:7.

As mentioned above, the connectivity server 300 may be implemented in any web-searchable server available over the Internet to accommodate connectivity records 304 for any number of client devices. In order to increase the likelihood of being found by a search engine, the connectivity server can be initially registered in the search engine, or be implemented in a web hotel or other large web site run by a well-known operator. The connectivity server may also be fitted with dedicated (and typically standardised) so-called “search tags” to further assist searching. As search engines utilise caching to a great extent to obtain rapid search results, changing or modifying the connectivity key on an existing web page may initially cause some delay in the search.

Client device A may also make use of caching such that all found locations of connectivity records can be cached in device A for subsequent use. For example, device A may cache the obtained IP address of device B in order to make a direct contact at a later occasion. Also, device A may cache the address of the connectivity server in order to read updated connectivity parameters directly therefrom without performing a web search.

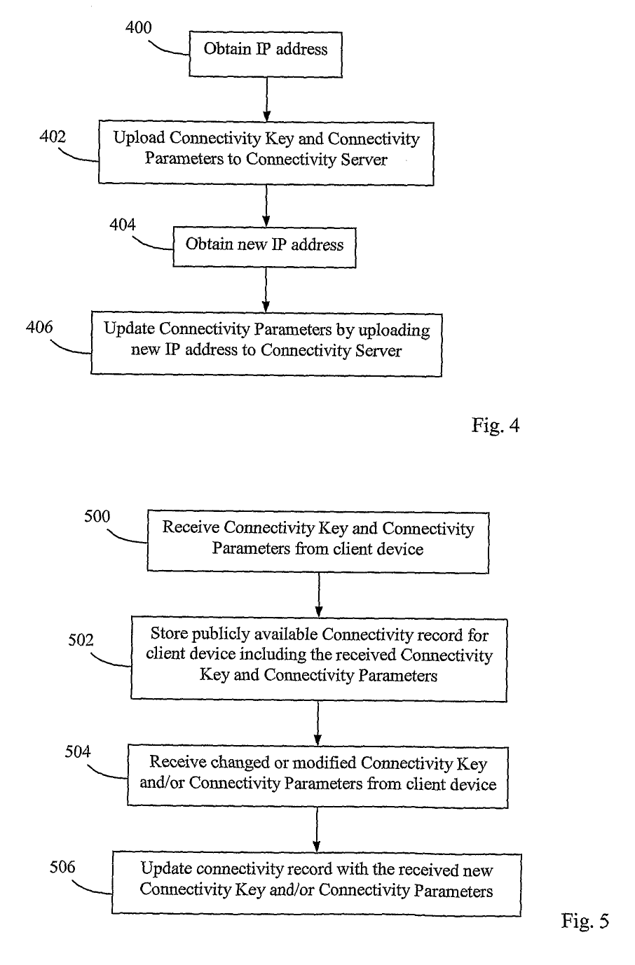

FIG. 4 is a flow chart with steps executed in a client device arrangement, in a basic procedure for making its communication address available to other client devices, persons and applications, in accordance with another embodiment. In a first step 400, the client device obtains an IP address for communication, e.g. by means of a PDP context when switched on, or by connecting to a fixed access point as described above.

A freely composed connectivity key and connectivity parameters are then uploaded to the connectivity server, in a following step 402. Thereby, a publicly available connectivity record containing the uploaded connectivity key and connectivity parameters can be stored for the client device in the connectivity server. The uploaded connectivity parameters include at least the IP address obtained in step 400. In this way, the IP address of the client device becomes available to other client devices, persons and applications by means of web searching, as described above for FIG. 3a.

At some point in this example, the client device obtains a new IP address different from the one obtained in step 400, in a next step 404, e.g. when switched on after a period of switched-off state rendering a new PDP context, or when connecting to a new access point in a network with fixed access points. In this embodiment, the client device is obliged to update the connectivity parameters in the connectivity server by uploading the new IP address thereto, in a final step 406. In an alternative embodiment, the currently used access network, or the home network of the client device, may be responsible for updating the IP address in the connectivity server using a suitable communication mechanism not necessary to describe here.

The client device may be configured with suitable means for performing the described steps 400-406 automatically without requiring further input from its user. However, the user may input a freely composed connectivity key to the client terminal before it is uploaded to the connectivity server in step 402. Alternatively, the client device may be configured to automatically select a default connectivity key after obtaining the IP address in step 400. The default connectivity key may be composed from the user's name, telephone number and/or other identification data.

A unique connectivity key may be achieved if based on existing identification mechanisms, e.g. an e-mail or a membership identity in MSN (which is a messenger service provided by Microsoft). Further, identification data from Skype or some gaming service may also be used for composing the connectivity key. In general, the authenticity of the connectivity key can be certified by forming the ID from a public key, e.g., in a private-public pair of keys used for encryption.

In the procedure described in FIG. 4, steps 400 and 402 may be somewhat modified such that the connectivity key is first uploaded separately before obtaining the IP address. Then, the connectivity parameters, including at least the obtained IP address, may be uploaded afterwards since the connectivity key and connectivity parameters can be uploaded independently. Different connectivity parameters may also be uploaded at different occasions.

FIG. 5 is a flow chart with steps executed in a connectivity server, in a basic procedure for making the communication address of a client device available to other client devices, persons and applications, in accordance with yet another embodiment. In a first step 500, the connectivity server receives from the client device a connectivity key and connectivity parameters including at least the IP address of the client device. As mentioned above, the connectivity key and connectivity parameters may be received independently at different occasions although being generally illustrated here as a single step.

In a next step 502, a publicly available connectivity record is stored for the client device including the received connectivity key and connectivity parameters. In this way, the IP address of the client device becomes available to other client devices, persons and applications by means of web searching, as described above for FIG. 3a. Alternatively, the connectivity record may contain the connectivity key and a received alias for the client device pointing to a separate database where the actual connectivity parameters are stored, such that another user device can retrieve the IP address basically in two stages instead of one, which will be described further below in another embodiment.

The next step 504 illustrates generally that any changed or modified connectivity key and/or connectivity parameters are received from the client device. For example, as in the process described for FIG. 4, the client device may at some point obtain a new IP address different from the one uploaded in step 500. Therefore, new connectivity parameters are received from the client device accordingly, including the changed IP address. Depending on the implementation, the client device may upload a new complete set of connectivity parameters (including the changed IP address) to replace the previously uploaded connectivity parameters, or only the changed IP address wherein the connectivity server updates the stored connectivity parameters accordingly.

A final step 506 generally illustrates that the connectivity server updates the stored connectivity record with the received new connectivity key and/or connectivity parameters, in response to the receiving step 504.

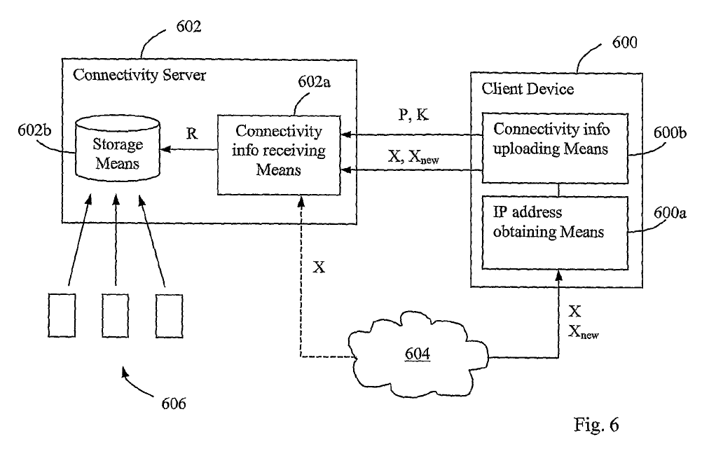

FIG. 6 is a functional block diagram illustrating a client device 600 and a connectivity server 602, according to further embodiments. The client device 600 and the connectivity server 602 are basically configured to participate in the procedures described above for FIGS. 3, 3a, 4 and 5. It should be noted that FIG. 6 is merely schematic and the logic functions represented by the blocks can be implemented by means of any suitable hardware and software.

The client device 600 comprises means 600a for obtaining an IP address X as communication address from a network 604 responsible for assigning IP addresses to connected devices, e.g. the current access network or the home network of client device 600. As discussed in the previous embodiments, the IP address may be changed for various reasons, and network 604 may therefore provide a new IP address X_{new} whenever that occurs. The client device 600 further comprises means 600b for uploading connectivity information to the connectivity server 602, including connectivity parameters P and a connectivity key K. The connectivity information uploading means 600b is also adapted to upload at least a new IP address X_{new} whenever a new IP address has been obtained from network 604, and any further changes or modifications of previously uploaded information, when applicable.

The connectivity server 602 comprises means 602a for receiving connectivity information uploaded from the client device 600, such as the shown connectivity parameters P and connectivity key K as well as any new IP address X_{new} when changed. Alternatively, as indicated by the dashed arrow, at least the IP address may be received from network 604 having assigned it to the client device, which may be the currently used access network or the home network of the client device.

The connectivity server 602 further comprises means 602b for storing a connectivity record R for the client device 600 including valid connectivity parameters and an associated connectivity key. Thereby, this information of the client device, including the IP address, becomes publicly available to other client devices, persons and applications 606, typically by means of web searching using a search engine (not shown).

The above-described embodiments can be modified and varied in several ways within the scope of the present invention. The described connectivity server has been described as a single server entity, although it may also be implemented as a distributed system of plural servers, as mentioned above. Moreover, the connectivity key of a specific client terminal may reside in a server entity and the associated connectivity parameters may be stored in a separate database.

An alternative embodiment for making a communication address of a client device B available to another client device A will now be described with reference to FIG. 7. In this embodiment, a connectivity server is implemented in a main server 700 that holds a record 702 of a client device B, containing a received connectivity key 704 and a received alias 706 for client device B. The connectivity server is further implemented in a distributed client database 708 that holds received connectivity parameters 710 for client device B corresponding to the alias 706, as indicated by the dashed line. In this embodiment, other client devices can use the alias 706 for accessing the connectivity parameters 710 in the client database 708. As in the previous examples, the connectivity parameters 710 include at least a communication address, or network address, in this case an IP address.

In a first step 7:1, client device B uploads the connectivity key 704 to connectivity server 700. In a next step 7:2, having obtained a currently valid IP address, client device B uploads its current connectivity parameters 710 to the client database 708, including at least the obtained IP address. In a following optional step 7:3, client device B also uploads its alias 706 to the connectivity server 700 for inclusion in the record 702. Alternatively, the connectivity server may assign the alias 706 to client device B, thereby omitting step 7:3. It should be noted that steps 7:1, 7:2 and 7:3 can basically be executed in any arbitrary sequence.

Any suitable alias 706 may be selected for client device B, depending on the implementation, such as a private name or identity valid in the client database 708. In this context, any suitable look-up mechanism based on the alias 706 may be used for retrieving the corresponding connectivity parameters 710 from the client database 708.

As in the embodiment of FIG. 3a, client device A enters a search query in a search engine 712 to search for client device B, in a step 7:4 (similar to step 3:3). Thereafter, search engine 712 finds a match in the connectivity key 704, as illustrated by a step 7:5 (similar to step 3:4), and delivers the search result to client device A in a step 7:6 (similar to step 3:5) in the form of a URL pointing to the connectivity record 702 of client device B in the main server 700. Client device A then fetches the connectivity record 702 from the main server 700 using the received URL, in a further step 7:7, and receives the alias 706 included therein. The alias may also include a URL or other reference pointing to the corresponding connectivity parameters 710 of client device B in the client database 708.

In a next step 7:8, client device A accesses client database 708 and retrieves the connectivity parameters 710 therefrom, using the URL in the received alias of B. Then finally, client device A can communicate with client device B in a step 7:9, using the IP address as well as any other useful information in the connectivity parameters 710.

Within the scope of the present invention, the embodiment of FIG. 7 may be modified by introducing further look-up steps involving a series of similar databases each providing a new alias for client device B pointing to the next database, until a final database provides the necessary connectivity parameters (i.e. at least the IP address). The present solution may also involve a series of individual server units making up the connectivity server, each providing a new pointer (such as a URL) to the next one, until a final server unit provides the desired connectivity parameters. For example, certain connectivity parameters of client device B may optionally be made available for device A at specific intermediate servers, reflecting that each server may contain a different type of information. One server may, e.g., handle user presence information, while another server may handle application specific information, and so forth.

In conclusion, the present invention provides a simple yet effective and flexible solution to the problem of generally providing communication addresses of client devices, by making them publicly available over the Internet from globally reachable web sites, i.e. the described connectivity server, by means of existing web search mechanisms.

In addition, other useful information embedded in the connectivity parameters and/or connectivity key can also be made available from the connectivity server without additional functionality. For example, a user can utilize the connectivity key for exposing any kind of information free of choice, as it has no limitations as to size and content. This is a great advantage in comparison with the traditional domain name registration where strictly limiting rules and schemes must be followed. The inventive connectivity key can further be used for controlling the availability by selecting its content to be matched in web searches in a desired and controllable manner.

Moreover, any information may be inserted in the connectivity key that could be helpful for the communication and/or applications. Thus, it is possible to adapt the connectivity key more or less temporarily to the type of communication and/or applications used. This flexibility of the connectivity key together with the flexibility of selecting different connectivity parameters for inclusion in the connectivity record can also be utilised to support different kinds of session and user mobility, as well as presence services.

When implementing any of the above-described embodiments, it is possible to restrict access to all or some of the connectivity parameters in the connectivity record for specific users or groups of users. For example, certain connectivity parameters may be encrypted requiring a proper key for access, whereas other connectivity parameters may be available to anyone. In another example, the entire web page hosting the connectivity record may require a login procedure (involving a username/password combination) for restricting access thereto.

Another advantage with the present invention compared to the domain name registration, is that a limitless number of such connectivity servers can be established without requiring any coordination or organization, as opposed to the DNS tree structure.

While the invention has been described with reference to specific exemplary embodiments, the description is only intended to illustrate the inventive concept and should not be taken as limiting the scope of the invention. Various alternatives, modifications and equivalents may be used without departing from the spirit of the invention, which is defined by the appended claims.

1. A method of making a currently valid communication address of a client device publicly available, which can be used for communication with the client device, comprising the following steps, as executed in said client device:
sending a freely composed connectivity key to a publicly available connectivity server, wherein said connectivity key is searchable by means of web searching using a search engine, and
sending connectivity parameters associated with the connectivity key to the connectivity server, said connectivity parameters including at least the communication address of the client device, which then becomes publicly available in the connectivity server by web searching of the associated connectivity key using said search engine to obtain a search result as a URL of the connectivity server, specifically pointing to a web page containing the connectivity key and associated communication address of the searched client device, wherein the communication address of the client device can be retrieved by means of said URL of the connectivity server.

2. A method according to claim 1, wherein said communication address is a network address including any of: an IP address, an MAC address, an SIP address and a DNS name.

3. A method according to claim 1, further comprising the step of updating said connectivity parameters in the connectivity server if a new currently valid communication address different from the previous one is obtained for the client device, by sending the new communication address to the connectivity server.

4. A method according to claim 1, wherein said connectivity key has been received as input from a user.

5. A method according to claim 1, wherein said connectivity key has been automatically selected by default.

6. A method according to claim 1, wherein said connectivity key contains user and/or device identification data.

7. A method according to claim 6, wherein the identification data includes a user name and/or a telephone number.

8. A method according to claim 6 wherein said connectivity key further contains descriptive information the user has selected for characterization.

9. A method according to claim 1, wherein said connectivity parameters further includes capabilities of the client device and/or application specific data.

10. A method according to claim 1, wherein encryption is used when sending the connectivity key and/or associated connectivity parameters to the connectivity server.

11. A method according to claim 1, wherein the connectivity server comprises a main server and a distributed separate client database to which said connectivity parameters are sent, and wherein an alias for said client device is sent to the main server that other client devices can use for accessing said client database and the connectivity parameters stored therein.

12. An arrangement in a client device for making a currently valid communication address of the client device publicly available, which can be used for communication with the client device, comprising:
means for sending a freely composed connectivity key to a publicly available connectivity server, wherein said connectivity key is searchable by means of web searching using a search engine, and
means for sending connectivity parameters associated with the connectivity key to the connectivity server, said connectivity parameters including at least the communication address of the client device, which then becomes publicly available in the connectivity server by web searching of the associated connectivity key using said search engine to obtain a search result as a URL of the connectivity server, specifically pointing to a web page containing the connectivity key and associated communication address of the searched client device, wherein the communication address of the client device can be retrieved by means of said URL of the connectivity server.

13. An arrangement according to claim 12, wherein said communication address is a network address including any of: an IP address, an MAC address, an SIP address and a DNS name.

14. An arrangement according to claim 12, further comprising means for updating said connectivity parameters in the connectivity server if a new currently valid communication address different from the previous one is obtained for the client device, by sending the new communication address to the connectivity server.

15. An arrangement according to claim 12, further comprising means for receiving said connectivity key as input from a user.

16. An arrangement according to claim 12, further comprising means for automatically selecting said connectivity key by default.

17. An arrangement according to claim 12, wherein said connectivity key contains user and/or device identification data.

18. An arrangement according to claim 17, wherein the identification data includes a user name and/or a telephone number.

19. An arrangement according to claim 17, wherein said connectivity key further contains descriptive information the user has selected for characterization.

20. An arrangement according to claim 12, wherein said connectivity parameters further includes capabilities of the client device and/or application specific data.

21. An arrangement according to claim 12, further comprising means for using encryption when sending the connectivity key and/or the associated connectivity parameters to the connectivity server.

22. An arrangement according to claim 12, wherein the connectivity server comprises a main server and a distributed separate client database to which said connectivity parameters are sent, further comprising means for sending an alias for said client device to the main server that other client devices can use for accessing said client database and the connectivity parameters stored therein.

23. A method of making a currently valid communication address of a client device publicly available, which can be used for communication with the client device, comprising the following steps, as executed in a publicly available connectivity server:
receiving a freely composed connectivity key which is searchable by means of web searching using a search engine,
receiving connectivity parameters associated with the connectivity key, said connectivity parameters including at least the communication address of the client device, and
storing a connectivity record for the client device including the received connectivity key and associated connectivity parameters, thereby making the connectivity parameters publicly available by web searching of the associated connectivity key using said search engine to obtain a search result as a URL of the connectivity server, specifically pointing to a web page containing the connectivity key and associated communication address of the searched client device, wherein the communication address of the client device can be retrieved by means of said URL of the connectivity server.

24. A method according to claim 23, wherein the received communication address is a network address including any of: an IP address, an MAC address, an SIP address and a DNS name.

25. A method according to claim 23, comprising the further step of updating said connectivity parameters in the connectivity record, if a new currently valid communication address obtained for the client device and different from the first one, is received.

26. A method according to claim 23, wherein the connectivity server is implemented in a web hotel or other large web site run by a known operator.

27. A method according to claim 23, wherein the received connectivity parameters further includes capabilities of the client device and/or application specific data.

28. A method according to claim 23, wherein encryption is used when receiving the connectivity key and/or the associated connectivity parameters.

29. A method according to claim 23, wherein said connectivity key and connectivity parameters are received from the client device.

30. A method according to claim 23, wherein at least said communication address is received from a communication network responsible for assigning a network address to the client device.

31. A method according to claim 23, wherein the connectivity server comprises a main server and a distributed separate client database in which said connectivity parameters are received, and wherein an alias for said client device is received in the main server that other client devices can use for accessing said client database and the connectivity parameters stored therein.

32. A method according to claim 23, wherein access to all or some of the connectivity parameters in the connectivity record is restricted to specific users or groups of users by means of encryption or login requirements.

33. An arrangement in a publicly available connectivity server for making a currently valid communication address of a client device publicly available, which can be used for communication with the client device, comprising:
means for receiving a freely composed connectivity key which is searchable by means of web searching using a search engine,
means for receiving connectivity parameters associated with the connectivity key, said connectivity parameters including at least the communication address of the client device, and
means for storing a connectivity record for the client device including the received connectivity key and associated connectivity parameters, thereby making the connectivity parameters publicly available by web searching of the associated connectivity key using said search engine to obtain a search result as a URL of the connectivity server, specifically pointing to a web page containing the connectivity key and associated communication address of the searched client device, wherein the communication address of the client device can be retrieved by means of said URL of the connectivity server.

34. An arrangement according to claim 33, wherein the received communication address is a network address including any of: an IP address, an MAC address, an SIP address and a DNS name.

35. An arrangement according to claim 33, further comprising means for updating said connectivity parameters in the connectivity record, if a new currently valid communication address obtained for the client device and different from the first one, is received.

36. An arrangement according to claim 33, wherein the connectivity server is implemented in a web hotel or other large web site run by a known operator.

37. An arrangement according to claim 33, wherein the received connectivity parameters further includes capabilities of the client device and/or application specific data.

38. An arrangement according to claim 33, further comprising means for using encryption when receiving the connectivity key and/or the associated connectivity parameters.

39. An arrangement according to claim 33, wherein said receiving means are adapted to receive the connectivity key and associated connectivity parameters from the client device.

40. An arrangement according to claim 33, wherein said connectivity parameters receiving means is adapted to receive at least said communication address from a communication network responsible for assigning a network address to the client device.

41. An arrangement according to claim 33, wherein access to all or some of the connectivity parameters in the connectivity record is restricted to specific users or groups of users by means of encryption or login requirements.
